(19) United States
(12) Patent Application Publication
(10) Pub. No.: US 2023/0212423 A1
(43) Pub. Date: Jul. 6, 2023

(54) A WATER-BASED COATING COMPOSITION

(71) Applicant: Covestro Deutschland AG, Leverkusen (DE)

(72) Inventors: Chenxi Zhang, Shanghai (DE); Feng Zhu, Shanghai (DE); Jinqi Li, Shanghai (DE); Weixi Lu, Shanghai (DE); Yu Wang Fu, Shanghai (DE)

(21) Appl. No.: 18/000,974

(22) PCT Filed: Jun. 25, 2021
(86) PCT No.: PCT/EP2021/067486

§ 371 Date: Dec. 7, 2022

(30) Foreign Application Priority Data
Jun. 30, 2020 (CN) 202010616600.6

(51) Int. Cl. C09D 175/14; C09D 7/62; C09D 7/40; C09D 7/65; C09D 5/02; C08J 7/04

(52) U.S. Cl. CPC C09D 175/14; C09D 7/62; C09D 7/67; C09D 7/65; C09D 5/027; C09D 5/022; C08J 7/0427; C08J 2369/00; C08J 2333/12; C08J 2475/14

(57) ABSTRACT

The present invention relates to a water-based coating composition, the preparation and use of the composition, a two-component coating system comprising the composition and use thereof, and an article obtained by coating with the composition or the two-component coating system. The water-based coating composition comprises a water-based UV resin; a silane-treated nanosized silicon oxide compound; and a photoinitiator; wherein per kilogram of the solid constituent of the water-based UV resin contains not less than 3 mol of ethylenically unsaturated groups, and wherein the weight ratio of the solid constituent of the nanosized silicon oxide compound to the solid constituent of the water-based UV resin is 11:20 to 73:100. The coating layer formed by the water-based coating composition of the present invention has high hardness and good adhesion, and is particularly suitable for electronic, electrical and communication equipment in the 5G field.

### TECHNICAL FIELD

The present invention relates to a water-based coating composition, the preparation and use of the composition, a two-component coating system comprising the composition and use thereof, and an article obtained by coating with the composition or the two-component coating system. The coating layer formed by the water-based coating composition of the present invention has high hardness and good adhesion, and is particularly suitable for electronic, electrical and communication equipment in the 5G field.

### PRIOR ART

The 5G era has high requirements on the communication signal penetration through housings of electronic, electrical and communication equipment, especially small equipment and portable equipment. At present, the commonly used material of the housings of the above-mentioned equipment is metal. Due to the strong shielding and attenuation of communication signals, it cannot meet the requirements of 5G equipment. In the field of portable equipment, such as the mobile phone industry, the manufacturers try to use plastic, glass or ceramic as the back cover material. Plastic has been widely studied due to its advantages of being light, wear-resistant, and not brittle. Among them, PC/PMMA composite board is widely popular because of its excellent glass-like effect. In order to increase the hardness of PC/PMMA composite boards, a coating is usually applied on its surface.

UV coatings are widely used in many applications, such as electronics and electrical appliances, for example mobile phones and notebooks because of its fast curing, high production efficiency, and high film fullness. UV coatings are applied to the plastic back cover of mobile phones, which can not only achieve the glossy or matte effect, but also improve the hardness, wear and scratch resistance, water-boiling resistance, solvent resistance, heat and cold resistance and special chemical resistance of the plastic back cover. There are three types of UV coatings, i.e. solvent-based UV coatings, solvent-free UV coatings and water-based UV coatings.

CN106459616A discloses a solvent-based coating agent and a film coated therewith, wherein the coating layer has enhanced mechanical and chemical resistance and sufficient formability for the 2D film insert molding. The composition of the coating agent may contain inorganic particles to improve mechanical durability, and the total amount of additives including inorganic particles is 0 to 20% by weight.

EP2604660A1 discloses a hard coating layer for plastic surfaces, wherein the boehmite nanoparticles are modified with an alkoxysilane compound on their surfaces and mixed with an acrylate to form an organic/inorganic hybrid material to achieve better overall performance. The system is solvent-based.

CN104736613A discloses a laminated pre-coated film with high hardness and excellent characteristics.

The system is solvent-based.

US20070238804A1 discloses a UV coating for protecting various plastic substrates such as ophthalmic lenses, polycarbonate plates, CR-39 plates or polystyrene. The UV coating is solvent-free and water-free, and the entire process is very complicated, which is not conducive to large-scale industrial production.

CN105765002A discloses a formable hard coating layer composition, and a coated film comprising a co-extruded PC/PMMA film and a coating obtained by coating with the hard coating layer composition. The composition is solvent-based and comprises a binder and a crosslinking agent. The binder comprises at least one acrylate oligomer and at least one monofunctional acrylic monomer, and the crosslinking agent comprises at least one multifunctional acrylic or methacrylic monomer.

US2010304113A provides a solvent-based coating composition and a coating film formed therefrom, comprising a binder containing a UV-curable functional group, a compound containing a UV-curable fluorine-containing functional group, a photoinitiator, and nanoparticles. The coating has excellent wear resistance and contamination resistance, such as fingerprint traces removability and scribble resistance.

Solvent-based UV coatings and solvent-free coatings contain large amounts of solvents with low flash point or reactive monomers, and thus are not conducive to the environment and human Water-based UV coatings not only have the advantages of fast curing, high production efficiency, high film fullness, etc. of UV coatings, but also have water as a dispersion medium instead of organic solvents, greatly reducing the volatilization of VOC, having no stimulation to human and being environmentally friendly. However, the existing water-based UV coatings still have worse performance compared with that of solvent-based or solvent-free UV coatings in terms of adhesion to the substrate surface, pencil hardness and water-boiling resistance of the coating layer.

CN107109101A discloses a coating composition for optical films comprising a UV-curable acrylate resin, mixed particles containing inorganic nanoparticles and carbon black, and a photoinitiator. The coating composition can help improving visibility and brightness.

In US20090269568A1, the performance of water-based UV coating is improved by introducing inorganic particles. The coating layer formed by the UV coating can exhibit such a high blocking resistance before deforming that the coating layer can be rolled up without any problems, while high stretch ratios can be achieved in the deformation process. When the amount of inorganic particles added is 1% to 60% by weight, the 750 g pencil hardness of the coating layer formed by the UV coating can reach 2H. However, the coating still cannot meet the requirements on the hardness of housings for electronic, electrical and communication equipment, especially on the hardness of the plastic back covers for mobile phones.

Therefore, it is desired to develop a water-based UV coating with good adhesion and high pencil hardness to meet the requirements on the performances of housings for 5G equipment, especially plastic back covers for mobile phones.

### SUMMARY OF THE INVENTION

The object of the present invention is to provide a water-based coating composition, the preparation and use of the composition, a two-component coating system comprising the composition and use thereof, and an article obtained by coating with the composition or the two-component coating system.

The water-based coating composition according to the present invention comprises:

at least a water-based UV resin;

at least a silane-treated nanosized silicon oxide compound; and

at least a photoinitiator;

wherein per kilogram of the solid constituent of the water-based UV resin contains not less than 3 mol of ethylenically unsaturated groups, and wherein the weight ratio of the solid constituent of the nanosized silicon oxide compound to the solid constituent of the water-based UV resin is 11:20 to 73:100.

One aspect of the present invention is to provide a method for preparing the water-based coating composition of the present invention, including mixing the water-based UV resin, the silane-treated nanosized silicon oxide compound and the photoinitiator in any desired manner.

Yet another aspect of the present invention is to provide the use of the water-based coating composition of the present invention for manufacturing articles.

Yet another aspect of the present invention is to provide an article comprising a substrate and a coating layer formed by applying the water-based coating composition of the present invention to the substrate.

Still another aspect of the present invention is to provide a method for manufacturing an article, including the steps of applying the water-based coating composition of the present invention to a substrate surface, drying and curing.

Still another aspect of the present invention is to provide a two-component coating system comprising component A and component B, wherein the component A is the water-based coating composition of the present invention, the component B is a crosslinking agent.

Still another aspect of the present invention is to provide the use of the two-component coating system of the present invention for manufacturing articles.

Yet another aspect of the invention is to provide an article comprising a substrate and a coating layer formed by applying the two-component coating system of the present invention to the substrate.

The water-based coating composition or two-component coating system of the present invention has the advantages of low VOC and low odor. The water-based UV resin and the silane-treated nanosized silicon oxide compound can form a dense inorganic/organic hybrid system. The coating layer formed by the water-based coating composition or two-component coating system has high pencil hardness, good conventional adhesion and good water-boiling adhesion. Good conventional adhesion indicates good adhesion between the coating and the substrate. Good water-boiling adhesion indicates good adhesion between the coating and the substrate under a condition of high temperature and high humidity and good hydrolysis resistance. High pencil hardness indicates that the coating layer formed by the coating composition has good scratch resistance. The water-based coating composition or the two-component coating system of the present invention can meet the requirements on housings for 5G equipment, especially plastic back covers for mobile phones.

### EMBODIMENTS

The invention provides a water-based coating composition, comprising:

at least a water-based UV resin;

at least a silane-treated nanosized silicon oxide compound; and

at least a photoinitiator;

wherein per kilogram of the solid constituent of the water-based UV resin contains not less than 3 mol of ethylenically unsaturated groups, and wherein the weight ratio of the solid constituent of the nanosized silicon oxide compound to the solid constituent of the water-based UV resin is 11:20 to 73:100.

The invention also provides a method for preparing the composition and use thereof, especially in the field of coatings, a two-component coating system comprising the composition and use thereof, and an article obtained by coating with the composition or the two-component coating system.

As used herein, the term “curing” refers to the process from liquid to solid state of the coating composition or the two-component coating system comprising the composition.

As used herein, the term “coating” refers to a chemical composition that can be applied to the surface of an object using different processes to form a continuous solid coating having a certain strength and firm adhesion.

The term “water-based UV resin” refers to water-based UV-curable resin.

The term “UV-curable resin” refers to a polymer that can generate a crosslinked polymer network by forming covalent bonds with chain extenders, crosslinkers and other polymer molecules when exposed to ultraviolet (UV) radiation.

As used herein, the term “polyurethane” refers to polyurethane-urea and/or polyurethane polyurea and/or polyurea and/or polythiourethane.

As used herein, the term “silane-treated nanosized silicon oxide compound” refers to a nanosized silicon oxide compound pretreated with silane.

Water-Based Coating Composition

The amount of organic solvent in the composition is preferably not more than 5% by weight, most preferably not more than 0.5% by weight, relative to the total weight of the composition.

The composition is a water-based system, and the composition has the characteristic of low VOC.

The weight ratio of the solid constituent of the nanosized silicon oxide compound to the solid constituent of the water-based UV resin is preferably 3:5 to 17:25.

Water-Based UV Resin

The water-based UV resin of the present invention is present as a dispersion or emulsion, which contains water.

The solid constituent of the water-based UV resin of the present invention refers to the solid component or effective component of the water-based UV resin.

Per kilogram of the solid constituent of the water-based UV resin contains not less than 3 mol, further preferably not less than 3.5 mol, and most preferably not less than 4 mol of ethylenically unsaturated groups.

The water-based UV resin is preferably an aqueous UV polyurethane-acrylate dispersion.

The amount of the solid constituent of the water-based UV resin is preferably 30% by weight to 50% by weight, relative to the total weight of the water-based UV resin.

The amount of the water-based UV resin is preferably 45% by weight to 50% by weight, relative to the total weight of the water-based coating composition.

The amount of the organic solvent remaining in the water-based UV resin is preferably less than 1.0% by weight, based on the total weight of the solid constituent of the water-based UV resin.

The aqueous UV polyurethane-acrylate dispersion is preferably one or more of the following: Bayhydrol UV 2689/2 and Bayhydrol UV 2720/1.

Silane-Treated Nanosized Silicon Oxide Compound

The solid constituent of the nanosized silicon oxide compound of the present invention refers to the solid component or effective component of the nanosized silicon oxide compound.

The particle size of the nanosized silicon oxide compound is preferably 8 nm to 18 nm, and most preferably 8 nm to 10 nm.

The nanosized silica compound is preferably one or more of the following: fumed nano-silica, aqueous nano-silica dispersion, aqueous nano-silica sol, solvent-based nano-silica solution and solvent-based nano-silica sol; further preferably one or more of the following: aqueous nano-silica dispersion and aqueous nano-silica sol; most preferably aqueous nano-silica dispersion.

The nanosized silicon oxide compound is preferably neutral or alkaline.

The nanosized silica compound is preferably an aqueous neutral or alkaline dispersion of nano-silica treated with silane on the surface, and more preferably an aqueous neutral or alkaline dispersion of nano-silica treated with silane on the surface having a particle size of 8 nm to 18 nm, most preferably Dispercoll S 3030/1.

The amount of the nanosized silicon oxide compound is 37 to 44% by weight, relative to the total weight of the water-based coating composition.

Photoinitiator

The photoinitiator is preferably one or more of the following: monomolecular initiators and bimolecular initiators.

The monomolecular initiator is preferably an aromatic ketone compound, and most preferably one or more of the following: benzophenones combined with tertiary amines, alkyl benzophenones, 4,4′-bis(dimethylamino) benzophenone (Michler's ketone), anthrone and halogenated benzophenone.

The bimolecular initiator is preferably one or more of the following: benzoin, derivatives of benzoin, benzil ketal, acylphosphine oxide, bisacylphosphine oxide, phenylglyoxylate, camphorquinone, α-aminoalkyl phenyl ketone, α,α-dialkoxy acetophenone and α-hydroxyalkyl phenyl ketone. The acylphosphine oxide is preferably 2,4,6-trimethylbenzoyldiphenylphosphine oxide.

The photoinitiator is most preferably one or more of the following: Omnirad, Irgacure, Darocur, and Esacure.

The amount of the photoinitiator is preferably 0.5% by weight to 5.0% by weight, most preferably 0.5% by weight to 1.0% by weight, relative to the total weight of the water-based coating composition.

Others

The water-based coating composition preferably further contains one or more of the following: silane coupling agents, additional aqueous polymer dispersions or emulsions, reactive diluents and additives.

The silane coupling agent is preferably one or more of the following: alkyl silane coupling agents, unsaturated group-containing silane coupling agents, amino silane coupling agents, epoxy silane coupling agents, mercapto silane coupling agents, ether-containing silane coupling agents and silane oligomers; most preferably unsaturated group-silane coupling agents.

The unsaturated group-containing silane coupling agent is preferably one or more of the following: vinyl silane coupling agents, acryloxysilane coupling agents and me thacryloxysilane coupling agents, further preferably one or more of the following: acryloxysilane coupling agents and methacryloxysilane coupling agents, most preferably one or more of the following: 3-acryloxypropyltrimethoxysilane and 3-methacryloxypropyltrimethoxysilane.

The amount of the silane coupling agent is preferably 0.1% by weight to 3.0% by weight, relative to the total weight of the water-based coating composition.

The additional aqueous polymer dispersion or emulsion is preferably one or more of the following: polyurethane dispersions, primary polyacrylate dispersions, secondary polyacrylate dispersions, ethylene-vinyl acetate copolymer emulsions, petroleum resin polymer emulsions, rosin polymer emulsions, polybutadiene dispersions, styrene-acrylonitrile copolymer emulsions, styrene butadiene copolymer emulsions, terpene phenolic copolymer emulsions, polychloroprene dispersions, and poly(vinylidene chloride) dispersions.

The amount of the additional aqueous polymer dispersion or emulsion is preferably 0 to 50% by weight, relative to the total weight of the water-based coating composition.

The reactive diluent is preferably an acrylate monomer reactive diluent, further preferably acrylate monomers having a functionality of three or more, and most preferably one or more of the following: trimethylolpropane triacrylate (TMPTA), ethoxylated trimethylolpropane triacrylate (EOTMPTA), glycerin-propoxylated triacrylate (GPTA), pentaerythritol tetraacrylate (PETA), ethoxylated pentaerythritol tetraacrylate (EOPETA) and dipentaerythritol hexaacrylate (DPHA).

The amount of the reactive diluent is preferably 1.0% by weight to 20.0% by weight, relative to the total weight of the water-based coating composition.

The additive is preferably one or more of the following: defoamers, wetting agents, leveling agents, anti-blocking agents, anti-fouling agents, anti-fingerprint agents and thickening agents.

The amount of the additive may be an amount well known to those skilled in the art, preferably 0% by weight to 20% by weight, further preferably 0% by weight to 10% by weight, most preferably 0.1% by weight to 10% by weight, relative to the total weight of the water-based coating composition.

Method for Preparing the Water-Based Coating Compositions

The method for preparing the water-based coating compositions preferably includes the following step of mixing the water-based UV resin, the silane-treated nanosized silicon oxide compound, the photoinitiator, the optional silane coupling agent, the optional additional aqueous polymer dispersion or emulsion, the optional reactive diluent and the optional additive in any desired manner.

The article is preferably a housing for 5G products, further preferably a front cover or a back cover for 5G products, and most preferably a back cover of a mobile phone.

The substrate is preferably made of thermoplastic polymers. The substrate may exist in the form of a plate or a laminated film. The laminated film may be double-layered or multi-layered.

The thermoplastic polymer is preferably one or more of the following: polymethyl methacrylate (PMMA), polyester, rigid PVC, cellulose ester, polystyrene (PS), polystyrene copolymer, polyacrylonitrile (PAN), ABS plastic, acrylonitrile methyl methacrylate (AMMA), acrylonitrile-styrene-acrylate (ASA), polyurethane (PUR), polyethylene (PE, PE-HD, -LD, -LLD, -C), polypropylene (PP), polyamide (PA), polycarbonate (PC) and polyethersulfone (PES) (abbreviations according to DIN 7728, Part I), further preferably one or more of the following: polycarbonate boards and PC/PMMA composite boards, most preferably PC/PMMA composite boards.

The PC/PMMA composite board is also called PC/acrylic composite board.

The polyester is preferably one or more of the following: PET (polyethylene terephthalate), PEN (polyethylene naphthalate), PBTP (polybutylene terephthalate) and UP (unsaturated polyester resin).

The polystyrene copolymer is preferably one or more of the following: SAN (styrene-acrylonitrile copolymer), SB (styrene-butadiene copolymer) and MBS (methyl methacrylate-butadiene-styrene copolymer).

A preferred method for manufacturing an article, which is a housing for 5G products, further preferably a front cover or a back cover for 5G products, and most preferably a back cover of a mobile phone, including the following steps of:

i) applying the water-based coating composition of the present invention to the PMMA surface of a PC/PMMA composite board;

ii) drying at 50° C. to 100° C. for 3 to 10 minutes; and

iii) photocuring at a curing rate of 1 m/min to 10 m/min and a radiation intensity of 100 mJ/cm² to 2000 mJ/cm².

The applying is preferably one or more of the following: curtain coating, spray coating, roller coating, knife coating, screen printing, and transfer printing.

The drying may be carried out by a method commonly used in the industry, preferably using an oven or a drying tunnel.

The dry film thickness of the coating layer is preferably 5 μm to 20 μm, most preferably 8 μm to 20 μm.

The drying temperature in the step ii) is preferably 60° C. to 80° C., and the drying time is preferably 5 minutes to 10 minutes.

The curing is preferably ultraviolet light photocuring, further preferably UV radiation curing, and most preferably using a UV device of M-40-2×1-URS-TR-SS type from IST.

The curing dose of the step iii) is measured using EIT UV Power Pack II dosimeter from EIT.

The step iii) is preferably carried out by passing through the UV device only once at a curing rate of 5 m/min and a radiation intensity of 700 mJ/cm².

The amount of the organic solvent in the two-component coating system is preferably not more than 5% by weight, most preferably not more than 0.5% by weight, relative to the total weight of the two-component coating system.

The two-component coating system is water-based and has a low VOC content.

The components A and B are preferably stored separately, and are mixed before use.

The weight ratio of the component A to the component B is preferably 2:1 to 100:1, further preferably 5:1 to 100:1, and most preferably 50:1 to 65:1.

The crosslinking agent is preferably one or more of the following: isocyanate group-containing compounds and carbodiimides.

The isocyanate group-containing compound is preferably a water-dispersible aliphatic polyisocyanate, most preferably one or more of the following: water-dispersible HDI-based polyisocyanates and water-dispersible IPDI-based polyisocyanates.

The NCO group content of the isocyanate group-containing compounds is preferably 10% by weight to 20% by weight.

The carbodiimides are preferably aqueous carbodiimides.

The NCN group content of the carbodiimides is preferably 3% to 5% by weight.

### EXAMPLES

Unless otherwise defined, all technical and scientific terms used herein have the same meaning as commonly understood by those skilled in the art to which this invention belongs. When the definition of terms in this specification contradicts the meaning commonly understood by those skilled in the art to which the present invention belongs, the definition described herein shall apply.

Unless otherwise stated, all numerical values used in the specification and claims to express the amounts of components, reaction conditions, etc. are understood to be modified by the term “about”. Therefore, unless indicated to the contrary, the numerical parameters set forth herein are approximate values that can be varied according to the required performance that needs to be obtained.

As used herein, “and/or” refers to one or all of the mentioned elements.

As used herein, “comprising” and “including” cover the case where there are only the mentioned elements and where there are other unmentioned elements besides the mentioned elements.

All percentages in the present invention are weight percentages, unless otherwise stated.

The analytical measurements of the present invention are all carried out at 23° C., unless otherwise stated.

Unless otherwise stated, the use of “a”, “an”, “an” and “the” in this specification is intended to include “at least one” or “one or more”. For example, “a component” refers to one or more components, so more than one component may be considered and may be employed or used in the implementation of the described embodiments.

The solid constituent of the dispersions was measured according to DIN-EN ISO 3251 using the HS153 moisture analyzer from Mettler Toledo. 1 gram of samples was weighed for the test.

Particle size test: The particle size of the dispersions was measured at 23° C. using laser spectroscopy after dilution with deionized water (measured using Zatasizer Nano ZS 3600 laser particle size analyzer from Malvern Instruments).

The pH value was measured at 23° C. using PB-10 pH meter from Sartorius, Germany.

Raw Materials and Reagents

Bayhydrol UV 2689/2: water-based UV resin, content of solid constituent: 41.4%, pH: 7.0 to 8.5, mole number of ethylenically unsaturated groups in per kilogram of the solid constituent of the water-based UV resin: 4 mol to 8 mol, available from Covestro Polymers (China) Co., Ltd.

Bayhydrol UV 2282: water-based UV resin, content of solid constituent: 39.6%, pH: 7.0 to 8.5, mole number of ethylenically unsaturated groups in per kilogram of the solid constituent of the water-based UV resin: less than 3 mol, available from Covestro Polymers (China) Co., Ltd.

Bayhydrol UH XP 2648: water-based UV resin, content of solid constituent: 35.6%, pH: 8.0, no ethylenically unsaturated groups, available from Covestro Polymers (China) Co., Ltd.

Dispercoll S 3030/1: aqueous dispersion of nano-silica treated with silane on the surface, content of solid constituent: 30.9%, pH: 10.5, particle size: 8 nm to 9 nm, available from Covestro Polymers (China) Co., Ltd.

Dispercoll S 2020: aqueous dispersion of nano-silica without treatment on the surface, content of solid constituent: 20.3%, pH: 3, particle size: 15 nm, available from Covestro Polymers (China) Co., Ltd.

SNOWTEX-40: aqueous dispersion of nano-silica without treatment on the surface, content of solid constituent: 40.2%, pH: 9 to 10.5, particle size: 20 nm to 25 nm, available from Nissan Chemical Industries, Ltd.

Omnirad 500: α-hydroxy ketone, surface photocuring initiator, purchased from IGM.

BYK 093: defoamer, purchased from BYK Chemical.

BYK 333: polyether modified silicone, wetting agent, purchased from BYK Chemical.

BYK 346: solution of polyether-modified siloxane, wetting agent, purchased from BYK Chemical TEGO Twin 4100: wetting agent, purchased from Evonik Industries AG.

TEGO Glide 410: wetting agent, anti-blocking agent, purchased from Evonik Industries AG.

Borchi Gel 0621: thickening agent, purchased from OMG Borchers GmbH.

Desmodur XP 2802: hydrophilically modified carbodiimide crosslinking agent, solid content: 40% by weight, NCN group content: 4.2% by weight, purchased from Covestro AG.

Bayhydur 305: polyisocyanate curing agent, water-dispersible hydrophilic aliphatic polyisocyanate based on HDI, NCO group content: 16.2% by weight, purchased from Covestro AG.

Methods for Performance Tests

1. Conventional Adhesion

According to the national standard GB/T 9286-1998 “Cross-cut test for paints and varnishes”, the hundred grid test was carried out on the UV-cured coating. As tapes, 3M Scotch 600 was used. The evaluation method for the adhesion was based on the standards in GB/T 9286-1998 “Cross-cut test for paints and varnishes” and ASTM D 3359 “Standard method for measuring adhesion by Tape Test”, method B. Table 1 shows the evaluation criteria for conventional adhesion. The acceptable value of conventional adhesion is 5B.

TABLE 1
Evaluation criteria for conventional adhesion

| Conventional | |
|---|---|
| adhesion | Description |
| 5B | The cutting edge is completely smooth |
| | without falling off |
| 4B | The coating layer falls partly off at |
| | the intersection of cuts, but the |
| | affected area is not significantly |
| | greater than 5% |
| 3B | The coating layer falls off at the |
| | intersection and/or along the edge of |
| | cuts. The affected area is significantly |
| | greater than 5%, but not significantly |
| | greater than 15% |
| 2B | The coating layer falls partly or |
| | completely off in large fragments |
| | along the edge of cuts, and/or partly |
| | or completely on different parts of |
| | the grids. The affected area is |
| | significantly greater than 15%, but |
| | not significantly greater than 35% |
| 1B | The coating layer falls partly or |
| | completely off in large fragments along |
| | the edge of cuts, and/or on some or all |
| | of the grids. The affected area is |
| | significantly greater than 35%, but not |
| | significantly greater than 65%. |
| 0B | The falling off degree exceeds |
| | that under 1B. |

2. Pencil Hardness

According to the national standard GB/T 6739-1996 “Determination of film hardness by pencil test”, MITSUBISHI UNI pencil was used and mounted on a dedicated pencil hardness tester. The load applied to the pencil tip was 1 kg, and the angle between the pencil and the horizontal plane was 45°. The pencil was pushed to slide forward about 10 mm long, and 5 lines in total was drawn in different positions. Then the pencil traces were wiped with an eraser, and the coating surface were evaluated for scratches. It is required that no more than 1 scratch is left on the coating surface. A pencil hardness of not less than 3H is considered acceptable.

3. Water-Boiling Adhesion

A film with the UV-cured coating layer was completely immersed in hot water at 80° C. for 30 minutes, taken out and gently dried by absorbing the moisture on the surface. The change in the appearance of the coating layer was evaluated and the hundred grid test was carried out. Methods and criteria for evaluating the adhesion are the same as that for the conventional adhesion. Water-boiling adhesion ≥4B is regarded as acceptable.

Table 2 shows the composition of the water-based coating compositions or two-component coating systems of Examples and Comparative Examples, and the results of performance tests for the coating layers formed by the coating compositions or two-component coating systems.

Method for Preparing the Water-Based Coating Compositions of Comparative Examples 1-5, 7, 9-11 and Examples 1-2

According to the content of the components shown in Table 2, the resin, the photoinitiator, the optional aqueous nano-silica dispersion, the optional additives and deionized water were added to a container and stirred until all components were dispersed uniformly. The compositions of Examples and Comparative Examples were obtained.

Method for Preparing the Two-Component Coating Systems of Comparative Examples 6, 8 and Examples 3-4

Preparation of component A: According to the content of the components shown in Table 2, the resin, the photoinitiator, the optional aqueous nano-silica dispersion, the optional additives and deionized water were added to a container and stirred until all components were dispersed uniformly.

Component A and component B were mixed and stirred at 200-500 rpm for 5 min to 10 min. After mixing, a 200-mesh filter screen was used for filtering. The two-component coating systems of Examples and Comparative Examples were obtained and ready for use.

Method for Preparing Coating Layers

The water-based coating compositions or the two-component coating systems were roller coated evenly on the PMMA surface of PC/PMMA films with a dry film thickness of about 8 μm to 15 μm. The coating layers were dried in an oven at 60° C. to 80° C. for about 5 minutes. A UV device of M-40-2×1-URS-TR-SS type from IST was used for curing (the curing dosage was measured by using EIT UV Power Pack II dosimeter). The coating layers were cured by passing through the UV device only once at a continuous curing rate of 5 m/min and a radiation intensity of about 600 mJ/cm² to 800 mJ/cm².

TABLE 2
the composition of coating compositions or two-component coating systems of Examples
and Comparative Examples, and the results of performance tests thereof

| | Composition/g | | | | | | |
|---|---|---|---|---|---|---|---|
| | | | | | Comp. | Comp. | Comp. |
| | Ex. 1 | Ex. 2 | Ex. 3 | Ex. 4 | Ex. 1 | Ex. 2 | Ex. 3 |
| Bayhydrol UV 2689/2 | 77.0 | 77.0 | 77.0 | 77.0 | 77.0 | 77.0 | 77.0 |
| Bayhydrol UV 2282 | | | | | | | |
| Bayhydrol UH XP 2648 | | | | | | | |
| Omnirad 500 | 1.0 | 1.0 | 1.0 | 1.0 | 1.0 | 1.0 | 1.0 |
| BYK 093 | 1.0 | 1.0 | 1.0 | 1.0 | 1.0 | 1.0 | 1.0 |
| BYK 333 | 0.3 | 0.3 | 0.3 | 0.3 | 0.3 | 0.3 | 0.3 |
| BYK 346 | 0.8 | 0.8 | 0.8 | 0.8 | 0.8 | 0.8 | 0.8 |
| TEGO Twin 4100 | 0.5 | 0.5 | 0.5 | 0.5 | 0.5 | 0.5 | 0.5 |
| TEGO Glide 410 | 0.6 | 0.6 | 0.6 | 0.6 | 0.6 | 0.6 | 0.6 |
| Borchi Gel 0621 | 0.1 | 0.1 | 0.1 | 0.1 | 0.1 | 0.1 | 0.1 |
| Deionized water | 15.7 | 15.7 | 15.7 | 15.7 | 15.7 | 15.7 | 15.7 |
| Dispercoll S 3030/1 | 61.6 | 69.3 | 61.6 | 61.6 | | 46.2 | 53.9 |
| SNOWTEX-40 | | | | | | | |
| Dispercoll S 2020 | | | | | | | |
| Desmodur XP 2802 | | | | 3.1 | | | |
| Bayhydur 305 | | | 2.5 | | | | |
| Weight ratio | 3:5 | 17:25 | 3:5 | 3:5 | 0 | 9:20 | 53:100 |

Results of performance tests

| Appearance of | | glossy | glossy | glossy | glossy | glossy | glossy | glossy |
|---|---|---|---|---|---|---|---|---|
| coating layers | | | | | | | | |
| Conventional adhesion | | 5B | 5B | 5B | 5B | 4B | 5B | 5B |
| Pencil hardness | | 3H | 3H | 3H | 3H | 2H | <2H | 3H |
| Water-boiling adhesion | | 5B | 5B | 4B | 5B | 0B | 3B | 0B |
| | Composition/g | | | | | | | |
| | Comp. | Comp. | Comp. | Comp. | Comp. | Comp. | Comp. | Comp. |
| | Ex. 4 | Ex. 5 | Ex. 6 | Ex. 7 | Ex. 8 | Ex. 9 | Ex. 10 | Ex. 11 |
| Bayhydrol UV | 77.0 | 77.0 | 77.0 | 77.0 | 77.0 | 77.0 | 77.0 | |
| 2689/2 | | | | | | | | |
| Bayhydrol UV | | | | | | | | 77.0 |
| 2282 | | | | | | | | |
| Bayhydrol UH | | | | 12.5 | 12.5 | | | |
| XP 2648 | | | | | | | | |
| Omnirad 500 | 1.0 | 1.0 | 1.0 | 1.0 | 1.0 | 1.0 | 1.0 | 1.0 |
| BYK 093 | 1.0 | 1.0 | 1.0 | 1.0 | 1.0 | 1.0 | 1.0 | 1.0 |
| BYK 333 | 0.3 | 0.3 | 0.3 | 0.3 | 0.3 | 0.3 | 0.3 | 0.3 |
| BYK 346 | 0.8 | 0.8 | 0.8 | 0.8 | 0.8 | 0.8 | 0.8 | 0.8 |
| TEGO Twin | 0.5 | 0.5 | 0.5 | 0.5 | 0.5 | 0.5 | 0.5 | 0.5 |
| 4100 | | | | | | | | |
| TEGO Glide | 0.6 | 0.6 | 0.6 | 0.6 | 0.6 | 0.6 | 0.6 | 0.6 |
| 410 | | | | | | | | |
| Borchi Gel | 0.1 | 0.1 | 0.1 | 0.1 | 0.1 | 0.1 | 0.1 | 0.1 |
| 0621 | | | | | | | | |
| Deionized | 15.7 | 15.7 | 15.7 | 15.7 | 15.7 | 15.7 | 15.7 | 15.7 |
| water | | | | | | | | |
| Dispercoll S | 77.0 | 115.5 | 46.2 | 46.2 | 46.2 | | | 59.3 |
| 3030/1 | | | | | | | | |
| SNOWTEX-40 | | | | | | 47.3 | | |
| Dispercoll S | | | | | | | 93.7 | |
| 2020 | | | | | | | | |
| Desmodur XP | | | | | | | | |
| 2802 | | | | | | | | |
| Bayhydur 305 | | | 2.3 | | 2.5 | | | |
| Weight ratio | 3:4 | 113:100 | 9:20 | 9:20 | 9:20 | 3:5 | 3:5 | 3:5 |

Results of performance tests

| | | | | | | | | |
|---|---|---|---|---|---|---|---|---|
| Appearance of | slightly | whitish | glossy | glossy | glossy | matt | grainy | glossy |
| coating layers | foggy | | | | | | | |
| Conventional | 5B | 5B | 4B | 4B | 1B | 4B | / | 0B |
| adhesion | | | | | | | | |
| Pencil | <2H | <2H | <2H | <2H | <2H | <2H | / | <2H |
| hardness | | | | | | | | |
| Water-boiling | 5B | 5B | 0B | 0B | 0B | 1B | / | 0B |
| adhesion | | | | | | | | |

Note:
The weight ratio refers to that of the solid constituent of the nanosized silicon oxide compound to the solid constituent of the water-based UV resin.

The water-based coating compositions or two-component coating systems of Examples 1˜4 of the present invention had good conventional adhesion, water-boiling adhesion and pencil hardness. Among them, Example 3-4 were two-component coating systems and contained a curing agent of polyisocyanate type and a curing agent of carbodiimide type respectively. As can be seen from the results of performance tests in Table 2, high pencil hardness, conventional adhesion and water-boiling adhesion can be achieved by adding different curing agents.

The composition of Comparative Example 1 contained no silane-treated nanosized silicon oxide compound, so that the conventional adhesion, the water-boiling adhesion and the pencil hardness of the coating layers prepared by the composition were unacceptable.

The weight ratios of the solid constituent of the nanosized silicon oxide compound to the solid constituent of the water-based UV resin of the coating compositions or coating systems of Comparative Examples 2-3, 6-8 were less than 11:20. The weight ratios of the solid constituent of the nanosized silicon oxide compound to the solid constituent of the water-based UV resin of the coating compositions of Comparative Examples 4-5 were greater than 73:100. The coating layers formed by the above coating compositions or coating systems failed to show a combination of good conventional adhesion, water-boiling adhesion and pencil hardness.

Compared with that in Example 1, an aqueous alkaline dispersion of nano-silica without treatment by silane was used in Comparative Example 9, and an aqueous acidic dispersion of nano-silica without treatment by silane was used in Comparative Example 10. The coating layer prepared by the water-based coating composition of Comparative Example 9 showed unacceptable conventional adhesion, water-boiling adhesion and pencil hardness. The coating layer formed by the water-based coating composition of Comparative Example 10 was grainy, i.e. had macroscopic small particles on the surface. That means the components of the composition were incompatible with each other, so that no performance tests could be carried out.

Compared with that in Example 1, the resin Bayhydrol UV 2282 was used in Comparative Example 11. The mole number of ethylenically unsaturated groups per kilogram of the solid constituent of Bayhydrol UV 2282 was less than 3.0 mol. The coating layer prepared by the composition containing said resin showed unacceptable conventional adhesion, water-boiling adhesion and pencil hardness.

Those skilled in the art can easily understand that the present invention is not limited to the foregoing specific details. The present invention can be implemented in other specific forms without departing from the spirit or main characteristics of the present invention. Therefore, from any point of view, the embodiments should be regarded as illustrative rather than restrictive. The scope of the present invention should be indicated by the claims rather than the foregoing descriptions. Therefore any changes, as long as they fall into the meaning and scope of the claims, should be regarded as belonging to the present invention.

1. A water-based coating composition, comprising:
at least a water-based UV resin;
at least a silane-treated nanosized silicon oxide compound; and
at least a photoinitiator;
wherein per kilogram of the solid constituent of the water-based UV resin contains not less than 3 mol of ethylenically unsaturated groups, and wherein the weight ratio of the solid constituent of the nanosized silicon oxide compound to the solid constituent of the water-based UV resin is 11:20 to 73:100.

2. The water-based coating composition according to claim 1, wherein per kilogram of the solid constituent of the water-based UV resin contains not less than 3.5 mol, most preferably not less than 4 mol of ethylenically unsaturated groups.

3. The water-based coating composition according to claim 1 or 2, wherein the water-based UV resin is an aqueous UV polyurethane-acrylate dispersion.

4. The water-based coating composition according to any one of claims 1 to 3, wherein the amount of the water-based UV resin is 45% to 50% by weight, relative to the total weight of the water-based coating composition.

5. The water-based coating composition according to any one of claims 1 to 4, wherein the weight ratio of the solid constituent of the nanosized silicon oxide compound to the solid constituent of the water-based UV resin is 3:5 to 17:25.

6. The water-based coating composition according to any one of claims 1 to 5, wherein the particle size of the nanosized silicon oxide compound is 8 nm to 18 nm.

7. The water-based coating composition according to any one of claims 1 to 6, wherein the nanosized silicon oxide compound is neutral or alkaline.

8. The water-based coating composition according to any one of claims 1 to 7, wherein the amount of the photoinitiator is 0.5% to 5.0% by weight, relative to the total weight of the water-based coating composition.

9. The water-based coating composition according to any one of claims 1 to 8, wherein the water-based coating composition further comprises one or more of the following: silane coupling agents, additional aqueous polymer dispersions or emulsions, reactive diluents and additives.

10. The water-based coating composition according to claim 9, wherein the amount of the additional aqueous polymer dispersion or emulsion is not more than 50% by weight, relative to the total weight of the water-based coating composition.

11. A method for manufacturing an article, including the steps of applying the water-based coating composition according to any one of claims 1 to 10 to a substrate surface, drying and curing.

12. A two-component coating system comprising component A and component B, wherein the component A is the water-based coating composition according to any one of claims 1 to 10, and the component B is a crosslinking agent.

13. The two-component coating system according to claim 12, wherein the crosslinking agent is one or more of the following: isocyanate group-containing compounds and carbodiimides.

14. Use of the water-based coating composition according to any one of claims 1 to 10 or the two-component coating system according to claim 12 or 13 for manufacturing articles.

15. An article comprising a substrate and a coating layer formed by applying the water-based coating composition according to any one of claims 1 to 10 to the substrate or comprising a substrate and a coating layer formed by applying the two-component coating system according to claim 12 or 13 to the substrate.

16. The article according to claim 15, wherein the substrate is a PC/PMMA composite board.

17. The article according to claim 15 or 16, wherein the article is a housing for 5G products, especially a front cover or a back cover for 5G products.
